(19) United States
(12) Patent Application Publication
(10) Pub. No.: US 2003/0152897 A1
(43) Pub. Date: Aug. 14, 2003

(54) Automatic navigation for virtual endoscopy

(76) Inventor: Bernhard Geiger, Cranbury, NJ (US)

Correspondence Address: Siemens Corporation, Intellectual Property Department, 186 Wood Avenue South, Iselin, NJ, 08830, US

(21) Appl. No.: 10/322,326

(22) Filed: Dec. 18, 2002

Related U.S. Application Data
(60) Provisional application No. 60/343,012, filed on Dec. 20, 2001.

(51) Int. Cl. G09B 23/28

(52) U.S. Cl. 434/262

(57) ABSTRACT

A method for navigating a viewpoint of a virtual endoscope in a lumen of a structure is provided. The method includes the steps of (a)determining an initial viewpoint of the virtual endoscope, the initial viewpoint having a first center point and first direction; (b)determining a longest ray from the initial viewpoint to the lumen, the longest ray having a first longest ray direction; (c)determining a second direction between the first direction of the initial viewpoint and the first longest ray direction; (d)turning the viewpoint to the second direction and moving the initial viewpoint a first predetermined distance in a first direction of the initial viewpoint; (e)calculating a second center point of the viewpoint; (f)moving the viewpoint to the second center point; and repeating steps (b) through (f) until the viewpoint reaches an intended target.

### PRIORITY

This application claims priority to an application entitled “AUTOMATIC NAVIGATION FOR VIRTUAL ENDOSCOPY” filed in the United States Patent and Trademark Office on Dec. 20, 2001 and assigned Ser. No. 60/343,012, the contents of which are hereby incorporated by reference.

### BACKGROUND OF THE INVENTION

1. Field of the Invention

The present invention relates generally to computer vision and imaging systems, and more particularly, to a system and method for automatic navigation of a viewpoint in virtual endoscopy.

2. Description of the Related Art

Virtual endoscopy (VE) refers to a method of diagnosis based on computer simulation of standard, minimally invasive endoscopic procedures using patient specific three-dimensional (3D) anatomic data sets. Examples of current endoscopic procedures include bronchoscopy, sinusoscopy, upper GI endoscopy, colonoscopy, cystoscopy, cardioscopy and urethroscopy. VE visualization of non-invasively obtained patient specific anatomic structures avoids the risks (e.g., perforation, infection, hemorrhage, etc.) associated with real endoscopy and provides the endoscopist with important information prior to performing an actual endoscopic examination. Such understanding can minimize procedural difficulties, decrease patient morbidity, enhance training and foster a better understanding of therapeutic results.

In virtual endoscopy, 3D images are created from two-dimensional (2D) computerized tomography (CT) or magnetic resonance (MR) data, for example, by volume rendering. These 3D images are created to simulate images coming from an actual endoscope, e.g., a fiber optic endoscope. This means that a viewpoint of the virtual endoscope has to be chosen inside a lumen of the organ or other human structure, and the rendering of the organ wall has to be done using perspective rendering with a wide angle of view, typically 100 degrees. This viewpoint has to move along the inside of the lumen, which means that a 3D translation and a 3D rotation have to be applied. Controlling these parameters interactively is a challenge.

A commonly used technique for navigating a viewpoint of a virtual endoscope is to calculate a “flight” path beforehand and automatically move the viewpoint of the virtual endoscope along this path. However, this technique requires a segmentation and trajectory calculation step that is time consuming and can fail.

### SUMMARY OF THE INVENTION

A system and method for automatic navigation of a viewpoint of an endoscope in virtual endoscopy is provided. The system and method of the present invention determines automatically a direction and orientation of a virtual endoscope. Therefore, a user needs to control only one parameter—forward or backward speed. The present invention allows immediate interactive navigation inside an organ without preprocessing, e.g., segmentation and path generation.

According to one aspect of the present invention, a method for navigating a viewpoint of a virtual endoscope in a lumen of a structure is provided. The method includes the steps of (a) determining an initial viewpoint of the virtual endoscope, the initial viewpoint having a first center point and first direction; (b) determining a longest ray from the initial viewpoint to the lumen, the longest ray having a first longest ray direction; (c) determining a second direction between the first direction of the initial viewpoint and the first longest ray direction; (d) turning the viewpoint to the second direction and moving the initial viewpoint a first predetermined distance in a first direction of the initial viewpoint; (e) calculating a second center point of the viewpoint; and (f) moving the viewpoint to the second center point. The method further includes the step of repeating steps (b) through (f) until the viewpoint reaches an intended target.

The method further includes the step of rendering a three-dimensional (3D) image of the structure, wherein the rendering step includes scanning the structure to acquire a plurality of two-dimensional (2D) images and rendering the 3D image from the plurality of 2D images.

In another aspect of the present invention, the second direction of the viewpoint is determined as a weighted sum of the first direction of the initial viewpoint and the first longest ray direction.

In a further aspect of the present invention, the calculating a second center point includes the steps of casting a plurality of rays in a plane perpendicular to second direction of the viewpoint; determining an intersection point of each of the plurality of rays with the lumen; and determining an average of the intersection points as the second center point. Alternatively, the calculating a second center point comprises the steps of determining a plurality of planes intersecting the first center point, each plane having a different orientation; casting a plurality of rays in each of the plurality of planes; determining an intersection point of each of the plurality of rays with the lumen; and determining an average of the intersection points as the second center point.

According to another aspect of the present invention, a program storage device readable by a machine, tangibly embodying a program of instructions executable by the machine to perform method steps for navigating a viewpoint of a virtual endoscope in a lumen of a structure includes the method steps of (a)determining an initial viewpoint of the virtual endoscope, the initial viewpoint having a first center point and first direction; (b)determining a longest ray from the initial viewpoint to the lumen, the longest ray having a first longest ray direction; (c)determining a second direction between the first direction of the initial viewpoint and the first longest ray direction; (d)turning the viewpoint to the second direction and moving the initial viewpoint a first predetermined distance in a first direction of the initial viewpoint; (e)calculating a second center point of the viewpoint; (f)moving the viewpoint to the second center point; and repeating steps (b) through (f) until the viewpoint reaches an intended target.

In still a further aspect of the present invention, a system for virtual endoscopy includes an image renderer for rendering a three-dimensional (3D) image of a structure from a plurality of two-dimensional (2D) images; a processor for navigating a viewpoint of a virtual endoscope in the 3D image of the structure; and a display device for displaying the viewpoint. The processor determines an initial viewpoint of the virtual endoscope, the initial viewpoint having a first center point, determines a longest ray from the initial viewpoint to the lumen, the longest ray having a first longest ray direction, determines a second direction between the first direction of the initial viewpoint and the first longest ray direction, turns the viewpoint to the second direction and moves the initial viewpoint a first predetermined distance in a first direction of the initial viewpoint, calculates a second center point of the viewpoint, and moves the viewpoint to the second center point.

The system further includes a scanner device for scanning the plurality of two-dimensional (2D) images of the structure and a cursor control device for determining a speed of movement of the viewpoint.

### BRIEF DESCRIPTION OF THE DRAWINGS

The above and other aspects, features, and advantages of the present invention will become more apparent in light of the following detailed description when taken in conjunction with the accompanying drawings in which:

FIG. 1 is a block diagram of an exemplary system for automatic navigation in virtual endoscopy in accordance with the present invention;

FIG. 2 is a flowchart illustrating a method for automatic navigation in virtual endoscopy in accordance with the present invention;

FIGS. 3(a) through 3(e) are several views of a virtual endoscope entering an organ or lumen of a structure for illustrating a method of automatic navigation in virtual endoscopy according to an embodiment of the present invention; and

FIG. 4 is a diagram illustrating a centering technique of the method of FIG. 2 in according with the present invention.

### DETAILED DESCRIPTION OF PREFERRED EMBODIMENTS

Preferred embodiments of the present invention will be described hereinbelow with reference to the accompanying drawings. In the following description, well-known functions or constructions are not described in detail to avoid obscuring the invention in unnecessary detail.

A system and method for automatic navigation of a viewpoint in virtual endoscopy is provided. The present invention employs a raycasting technique to a rendered perspective image of a structure or internal organ of a human, e.g., a colon. In raycasting, for every pixel of the image displayed, a ray is cast and its intersection with an organ wall is calculated. In the method of the present invention, the longest ray is stored and its intersection point with the organ wall is calculated for an orientation of the virtual endoscope. The position of the virtual endoscope is chosen to look into the direction of the longest ray. In this way, the virtual endoscope always looks into the direction of the farthest point in the viewpoint. The endoscope is then pushed along this direction by an amount corresponding to a selected user speed.

However, this would mean that the virtual endoscope viewpoint would always move close to organ walls in the case of bends or folds. Therefore, additional rays are chosen orthogonally around the viewpoint to re-center the viewpoint. All intersection points of these lateral rays with the organ walls are added and the result is project onto the orthogonal plane of the virtual endoscope resulting in a new position of the virtual endoscope.

Additionally, to avoid a shaking motion, the newly calculated orientation is blended with a previous orientation using a weighting factor that depends on the speed (delta displacement) of the viewpoint of the virtual endoscope. If the speed is high, the new orientation has a higher weight; if the speed is low, the previous orientation has a higher weight.

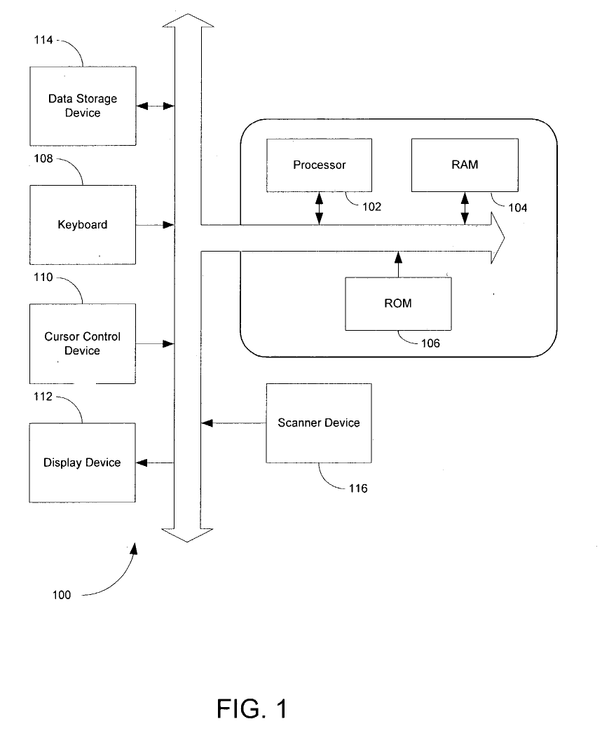

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture such as that shown in FIG. 1. Preferably, the machine 100 is implemented on a computer platform having hardware such as one or more central processing units (CPU) 102, a random access memory (RAM) 104, a read only memory (ROM) 106 and input/output (I/O) interface(s) such as keyboard 108, cursor control device (e.g., a mouse or joystick) 110 and display device 112. The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device 114 and a printing device. Furthermore, a scanner device 116, for example an X-ray machine or MRI (magnetic resonance imaging) machine, may be coupled to the machine 100 for collecting two-dimensional (2D) image data, which is processed and rendered as three-dimensional (3D) image data on the display device 112.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

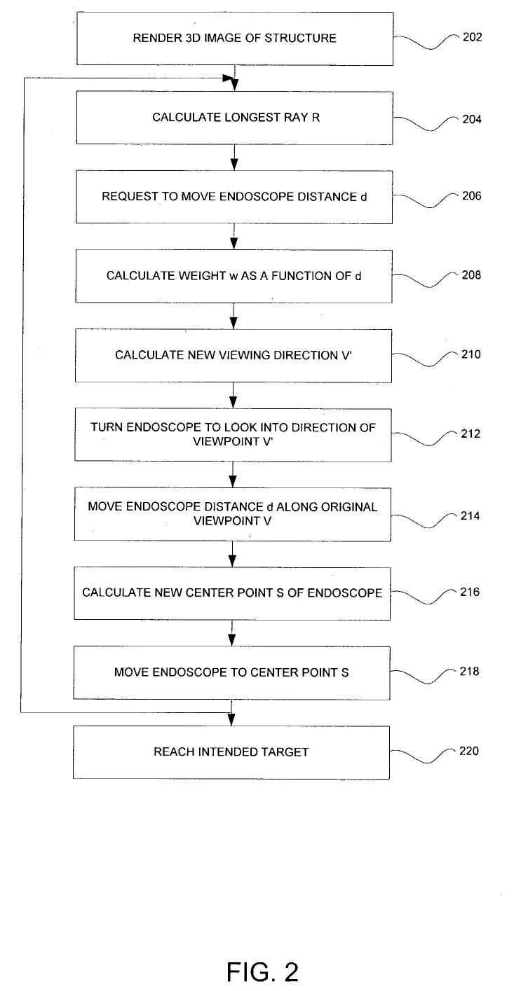

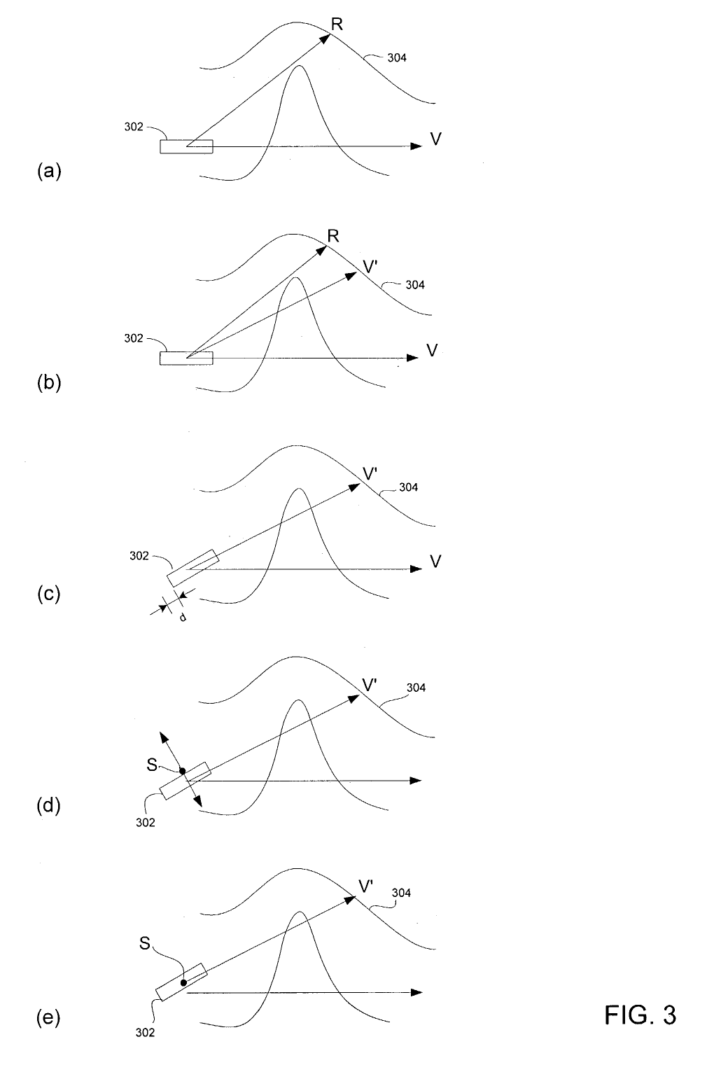

Referring to FIGS. 2 and 3, a method for automatic navigation of a viewpoint in a virtual endoscope according to an embodiment of the present invention will be described, where FIG. 2 is a flowchart illustrating the method and FIG. 3 shows several views of a virtual endoscope navigating an organ, e.g., a colon. It is to be understood that in operation a user will see the viewpoint of the virtual endoscope on the display device 112 as though an actual endoscopic procedure is being performed. The views illustrated in FIG. 3 are for the purposes of explaining an embodiment of navigating a viewpoint and will not be displayed.

Additionally, although the colon is used to describe the system and method of the present invention, it is to be understood that the system and method of the present invention can be applied to any human or animal body organ or structure which have hollow lumens such as blood vessels, airways, etc.

Before the navigation method is performed, the person to be tested is subject to a scanning procedure via scanning device 116, such as a helical computed tomography (CT) scanner or magnetic resonance imaging (MRI) scanner. After various scans are completed and a series of two-dimensional (2D) images are acquired, a 3D image of the organ to be viewed is rendered on the display device 112 by conventional rendering methods (step 202), such as raycasting, splatting, shear-warp, 3D texture-mapping hardware-based approaches, etc.

FIG. 3(a) shows a virtual endoscope 302 at an initial position entering a vitrual lumen 304 of a rendered image, looking in direction of viewpoint V. Longest ray direction R is obtained after rendering the image (step 204). If raycasting is used as the image rendering method, the longest ray R is automaticcaly calculated. Otherwise, the longest ray could be calculated by casting rays after the image has been rendered by any known image rendering technique as desecribed above. After the longest ray R has been calculated, the user, e.g., surgeon or radiologist, is requested to move the viewpoint of the virtual endoscope by a distance d (step 206), for example, by moving the mouse or using a joystick.

Referring to FIG. 3(b), a new orientation viewpoint V′is to be calculated as a weighted sum of the initial direction V and the longest ray direction R (steps 208 and 210), as follows:

w=minimum(abs(d/f), 1.0) (1)

where f is a scaling factor, and

V′=wR+(1−w)V (2)

The weight w is chosen so that at a slow speed (low deplacement d) the initial direction V is dominant (low change in direction) and, at higher speed, the longest ray direction R is dominant (fast change in direction). The weighting step is performed to reduce oscillation and shaky motion, as will be described below. The scaling factor f is used to tune the speed of the virtual endoscope, where a high vlaue of f makes the virtual endoscope slower and a low value of f makes the virtual endoscope slower.

Referring to FIG. 3(c), the endoscope 118 is turned to look into the new viewing direction V′ (step 212) and then moved by distance d along the initial viewing direction V (step 214). Then, a new center point S is calculated for the virtual endoscope 302, as shown in FIG. 3(d).

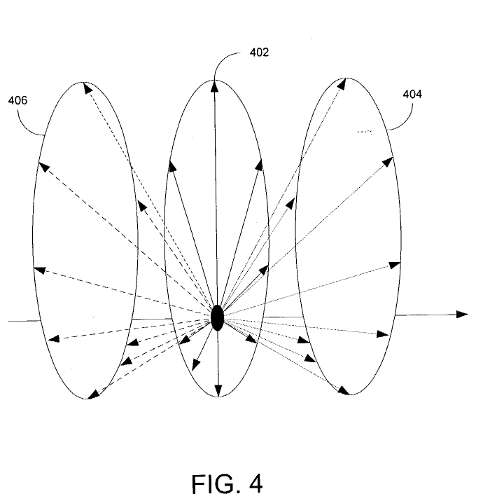

To center the endoscope (step 216), lateral rays are cast in a plane perpendicular to the viewpoint of the virtual endoscope 302; in all directions, for example, 8 lateral rays of varying lengths are cast every 40 degrees to form a circular pattern 402 as shown in FIG. 4. The intersection of the rays with the structure wall are calculated and projected into the perpendicular plane. The center point S is calculated as the average of these points.

Alternatively, the center point S can be calcluated using another circular pattern of 8 rays pointing forwards 404 and another circular pattern of 8 rays pointing backwards 406. More rays provide greater stability and accuracy. In a further embodiment, 5 circular patterns with 8 rays each are used: rays in the orthogonal plane, rays that are tilted 20 deg forwards, and 20 deg backwards, and rays tilted 45 deg forward and 45 deg backwards. All the vectors from the virtual endoscope position to the intersection points with a surface of the structure are added, and the resulting vector is projected into the orthogonal plane. This point is an approximation of the center and will be used as a new viewpoint position.

It is to be appreciated shaking happens when the virtual endoscope 302 moves laterally from one viewpoint to another (due to the centering step). If the virtual endoscope is pushed slowly, changes in the longest ray direction would create changes in the centering step, which results in the lateral motion. This is especially noticable when turning around a bend, e.g., a fold in a lumen. In this case, modifying the weight will reduce changes of the orientation and changes of the centering step and hence will reduce lateral motion.

The virtual endoscope 302 will now be shifted into the center position S, keeping its orientation toward viewpoint V′ (step 218), as shown in FIG. 3(e). The method will be repeated until the virtual endoscope 302 reaches its intended target (step 220), e.g., a tumor, nodule, etc.

As opposed to prior art methods which “fly” through internal structures, the method of the present invention does not require the calculation of a flight path before starting the navigation resulting in significant time savings.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A method for navigating a viewpoint of a virtual endoscope in a lumen of a structure, the method comprising the steps of:
(a)determining an initial viewpoint of the virtual endoscope, the initial viewpoint having a first center point. and first direction;
(b)determining a longest ray from the initial viewpoint to the lumen, the longest ray having a first longest ray direction;
(c)determining a second direction between the first direction of the initial viewpoint and the first longest ray direction;
(d)turning the viewpoint to the second direction and moving the initial viewpoint a first predetermined distance in a first direction of the initial viewpoint;
(e)calculating a second center point of the viewpoint; and
(f)moving the viewpoint to the second center point.

2. The method as in claim 1, further comprising the step of repeating steps (b) through (f) until the viewpoint reaches an intended target.

3. The method as in claim 1, further comprising the step of rendering a three-dimensional (3D) image of the structure.

4. The method as in claim 3, wherein the rendering step further includes scanning the structure to acquire a plurality, of two-dimensional (2D) images and rendering the 3D image from the plurality of 2D images.

5. The method as in claim 3, wherein the determining a longest ray step and the rendering step are performed by a raycasting image rendering technique.

6. The method as in claim 1, wherein the second direction of the viewpoint is determined as a weighted sum of the first direction of the initial viewpoint and the first longest ray direction.

7. The method as in claim 6, wherein the weighted sum is calculated as
V′=wR+(1−w)V
where V is the direction of the initial viewpoint, R is the first longest ray direction and w is a weight factor.

8. The method as in 7, wherein the weight factor w is calculated as
w=minimum(abs(d/f), 1.0)
where d is the first predetermined distance and f is a scaling factor.

9. The method as in claim 1, wherein the calculating a second center point comprises the steps of:
casting a plurality of rays in a plane perpendicular to second direction of the viewpoint;
determining an intersection point of each of the plurality of rays with the lumen; and
determining an average of the intersection points as the second center point.

10. The method as in claim 1, wherein the calculating a second center point comprises the steps of:
determining a plurality of planes intersecting the first center point, each plane having a different orientation;
casting a plurality of rays in each of the plurality of planes;
determining an intersection point of each of the plurality of rays with the lumen; and
determining an average of the intersection points as the second center point.

11. A program storage device readable by a machine, tangibly embodying a program of instructions executable by the machine to perform method steps for navigating a viewpoint of a virtual endoscope in a lumen of a structure, the method steps comprising:
(a)determining an initial viewpoint of the virtual endoscope, the initial viewpoint having a first center point and first direction;
(b)determining a longest ray from the initial viewpoint to the lumen, the longest ray having a first longest ray direction;
(c)determining a second direction between the first direction of the initial viewpoint and the first longest ray direction;
(d)turning the viewpoint to the second direction and moving the initial viewpoint a first predetermined distance in a first direction of the initial viewpoint;
(e)calculating a second center point of the viewpoint; and
(f)moving the viewpoint to the second center point.

12. The program storage device as in claim 11, further comprising the step of repeating steps (b) through (f) until the viewpoint reaches an intended target.

13. The program storage device as in claim 11, further comprising the step of rendering a three-dimensional (3D) image of the structure.

14. The program storage device as in claim 13, wherein the rendering step further includes scanning the structure to acquire a plurality of two-dimensional (2D) images and rendering the 3D image from the plurality of 2D images.

15. The program storage device as in claim 13, wherein the determining a longest ray step and the rendering step are performed by a raycasting image rendering technique.

16. The program storage device as in claim 11, wherein the second direction of the viewpoint is determined as a weighted sum of the first direction of the initial viewpoint and the first longest ray direction.

17. The program storage device as in claim 16, wherein the weighted sum is calculated as
V′=wV+(1−w)R
Where V is the direction of the initial viewpoint, R is the first longest ray direction and w is a weight factor.

18. The program storage device as in 17, wherein the weight factor w is calculated as
w=minimum(abs(d/f), 1.0)
where d is the first predetermined distance and f is a scaling factor.

19. The program storage device as in claim 11, wherein the calculating a second center point comprises the steps of:
determining a plurality of planes intersecting the first center point, each plane having a different orientation;
casting a plurality of rays in each of the plurality of planes;
determining an intersection point of each of the plurality of rays with the lumen; and
determining an average of the intersection points as the second center point.

20. A system for virtual endoscopy comprising:
an image renderer for rendering a three-dimensional (3D) image of a structure from a plurality of two-dimensional (2D) images;
a processor for navigating a viewpoint of a virtual endoscope in the 3D image of the structure; and
a display device for displaying the viewpoint.

21. The system as in claim 20, wherein the processor determines an initial viewpoint of the virtual endoscope, the initial viewpoint having a first center point and first direction, determines a longest ray from the initial viewpoint to the lumen, the longest ray having a first longest ray direction, determines a second direction between the first direction of the initial viewpoint and the first longest ray direction, turns the viewpoint to the second direction and moves the initial viewpoint a first predetermined distance in a first direction of the initial viewpoint, calculates a second center point of the viewpoint, and moves the viewpoint to the second center point.

22. The system as in claim 20, further comprising a scanner device for scanning the plurality of two-dimensional (2D) images of the structure.

23. The system as in claim 21, further comprising a cursor control device for determining a speed of movement of the viewpoint.
